(19) United States
(12) Patent Application Publication
(10) Pub. No.: US 2023/0258602 A1
(43) Pub. Date: Aug. 17, 2023

(54) INTEGRATION METHOD OF AT LEAST ONE PIEZOELECTRIC TRANSDUCER WITHIN POLYMER AND COMPOSITE PARTS MANUFACTURED USING 3D PRINTING TECHNIQUES

(71) Applicants: UNIVERSITE DE TECHNOLOGIE DE COMPIEGNE, Compiegne (FR); CENTRE NATIONAL DE LA RECHERCHE SCIENTIFIQUE, Paris (FR)

(72) Inventors: Walid HARIZI, Compiegne (FR); Corentin TULOUP, Montreal (CA); Zoheir ABOURA, La Croix Saint Ouen (FR)

(73) Assignees: UNIVERSITE DE TECHNOLOGIE DE COMPIEGNE, Compiegne (FR); CENTRE NATIONAL DE LA RECHERCHE SCIENTIFIQUE, Paris (FR)

(21) Appl. No.: 18/012,757

(22) PCT Filed: Jun. 24, 2020
(86) PCT No.: PCT/EP2020/067762

§ 371 Date: Dec. 23, 2022

(51) Int. Cl. G01N 29/04; G01N 29/24; B33Y 80/00; B33Y 10/00

(52) U.S. Cl. CPC G01N 29/043; G01N 29/2475; B33Y 80/00; B33Y 10/00; G01N 2291/0258

(57) ABSTRACT

A method of manufacturing a part having at least one piezoelectric measurement device integrated inside, the method comprising the following successive steps:
Using an additive method to obtain at least a first portion of the part, with at least one cavity being at least partly formed in said portion;
Stopping the additive method;
Placing at least one piezoelectric transducer of the piezoelectric measurement device in said cavity; and
Using an additive method to create at least a second portion of the part so that the at least one transducer is held captive between at least the first and second portions.

The invention relates to a method of manufacturing a part having at least one piezoelectric measurement device integrated inside.

### BACKGROUND OF THE INVENTION

Functionalization consists in imparting an additional ability to a given Part. For example, it is known to integrate a transducer in a part in order to make it ‘smart’.

Specifically, the transducer becomes a component of its host part and serves as an information vector during all steps of the lifecycle of the part: from manufacturing (Process Monitoring PM) to recycling steps, passing through service life (Structural Health Monitoring SHM). There is then no need to use external Non-Destructive Testing (MDT) methods for monitoring said part, nor any need to stop using the part while it is inspected.

Savings in money and time can thus be considerable. In addition, the integrated transducer makes it easier to detect damage in real-time during service life of the part, thereby making it possible, on a more global scale, to reduce the safety factors applied at the design and dimensioning steps of this part.

Finally, because it is embedded inside the material, the piezoelectric transducer is thus protected from its external environment, which increases its sensitivity and durability.

Consequently, this type of functionalization presents a considerable advantage, industrially speaking.

Unfortunately, present methods of creating a part having at least one transducer integrated therein are still found to be very labor-intensive, thus not making it possible to envisage production on a large scale.

### OBJECT OF THE INVENTION

An object of the invention is to propose a method of manufacturing a part having at least one transducer integrated inside, that can be implemented more quickly.

### SUMMARY OF THE INVENTION

In order to achieve this object, the invention proposes a method of manufacturing a part having at least one piezoelectric measurement device integrated inside, the method comprising the following successive steps:
Using an additive method to obtain at least a first portion of the part, with at least one cavity being at least partly formed in said portion;
Stopping the additive method;
Placing at least one piezoelectric transducer of the piezoelectric measurement device in said cavity; and
Using an additive method to create at least a second portion of the part so that the at least one transducer is held captive between at least the first and second Portions.

Consequently, the invention makes it possible to adapt the additive method upstream so that the part is fabricated directly with the cavity for the arrangement of the transducer in the part. The transducer can then be placed in the part simply and quickly.

Consequently, the invention enables a part to be obtained easily and quickly, containing a piezoelectric measurement device. Also, the invention can provide very good repeatability from one part to another.

As a result, it is possible to envisage producing said parts on an industrial scale.

Advantageously, as a result of acting from the beginning to provide a cavity in the part for receiving the piezoelectric transducer, it is possible to implant the transducer better in the part. This serves to limit any risk of the transducer being too intrusive for the part, and improve the transducer/part interface quality.

The transducer is also arranged in the core of the part, and not on its surface or remotely from the part, thereby enabling it to be more sensitive to the physical phenomena occurring in the part (like for example cooling phases, phases changes, presence of porosities . . . ) and/or to interact better with them (to monitor the health state of the part throughout its lifetime, for example to evaluate the stresses and/or strains to which the part is subjected in real-time during its service life, to detect in real-time the initiation of damage into, the part, to track the propagation of such damage until the final failure of the part . . . ).

In the present application, terms such as “top”, “bottom”, “high”, “low”, “above”, “below”, “thickness” should be understood with the part being in the position it occupies while it is being created and is still in place in the additive machine(s) used to manufacture it in accordance with the invention.

Optionally, in addition to the piezoelectric transducer, the measurement device comprises two connection wires that are connected to said transducer.

These connection wires, exiting the part, allow information retrieval from the embedded piezoelectric transducer.

Optionally, at least one of the first portion and the second portion includes a second cavity, being at least partly formed in one of said portions, said second cavity being defined during additive method of the portion in question, at least one of the connection wires being arranged in said second cavity.

Optionally, the method includes the step of securing at least one of the connection wires to a cavity of the Part.

Optionally, the method includes the step of applying electrically conductive material in at least one area of contact between the transducer and at least one of the connection wires.

Optionally, the piezoelectric transducer is based on Lead Zirconate-Titanate (LZT or PIT) material.

Optionally, the piezoelectric transducer is based on polyvinylidene fluoride (PVDF) material.

Optionally, at least one of the two portions is made of polymer material or Composite material.

Optionally, at least one of the two portions is based on thermoplastic material.

Optionally, the method includes the step of electrically insulating the at least one cavity.

Optionally, the method includes the step of securing at least the transducer to its cavity.

This limits a risk of transducer displacement or transducer destruction during closing of the cavity with the following layers of additive material.

Optionally, the transducer is adhesively bonded to its cavity in order to secure it into its cavity.

Optionally, the method includes a step of inserting at least two piezoelectric measurement devices in the part.

Optionally, the method includes a step of inserting two of the devices in the same layer of the part.

Therefore said two piezoelectric measurement devices forming a planar network.

Optionally, the method includes a step of inserting two of the devices in different layers of the part.

Therefore said two piezoelectric measurement devices forming a through-the-thickness network.

The invention also provides a computer program comprising instructions enabling a calculation member to perform the method as specified above.

The invention also provides storage means for storing a computer program comprising instructions enabling a calculation member to perform the method as specified above.

Other characteristics and advantages of this invention appear on reading the following description of a particular implementation of the invention.

### BRIEF DESCRIPTION OF THE DRAWINGS

The invention can be better understood in the light of the following description given with reference to the accompanying figures, in which:

FIG. 1a shows a first step in creating a part in a first particular implementation of the invention;

FIG. 1b shows the second step in creating a part in the first particular implementation of FIG. 1a;

FIG. 1c shows the third step in creating a part in the first particular implementation of FIG. 1a;

FIG. 1d shows the fourth step in creating a part in the first particular implementation of FIG. 1a;

FIG. 1e shows the fifth step in creating a part in the first particular implementation of FIG. 1a;

FIG. 1f shows the sixth step in creating a part in the first particular implementation of FIG. 1a;

FIG. 1g shows the seventh step in creating a part in the first particular implementation of FIG. 1a;

FIG. 2a is a perspective view of the part manufactured during the steps shown in FIGS. 1a to 1g;

FIG. 2b is a view of the part shown in FIG. 2a using a cross-section (section being normal to the longitudinal axis X of the part) going through the middle of an embedded and wired piezoelectric transducer of said part, with an enlargement of a portion of said cross section;

FIG. 3 is a perspective view of another part, which is a dumbbell specimen, fabricated by steps similar to those shown in FIGS. 1a to 1g;

FIG. 4 is a perspective view of another part, which is a partially hollow cylindrical part, fabricated by steps similar to those shown in FIGS. 1a to 1g;

FIG. 5 is a perspective view of another part, which does not extend through a rectilinear direction, fabricated by steps similar to those shown in FIGS. 1a to 1g; and

FIG. 6a to FIG. 6i shows the steps of creating a part in a second particular implementation of the invention.

### DETAILED DESCRIPTION OF THE INVENTION

The method of manufacturing a part in a first particular implementation of the invention enables parts to be obtained in a variety of shapes (2D, 3D, planar, curved, etc.) and dimensions.

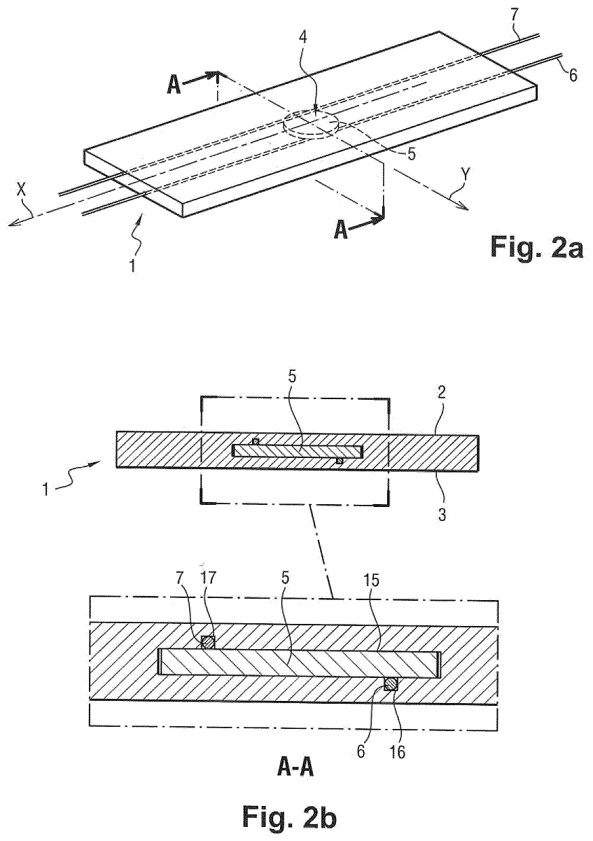

With reference to FIG. 2a and FIG. 2b, there follows a description of a particular, non-limiting example of such a part.

In this example, the part comprises a body 1 that is in the form of a rectangular parallelepiped of small thickness. The body 1 thus presents two main faces: a top face 2 and a bottom face 3.

By way of example, the entire body 1 of the part is made of a non-composite material. The used resin is optionally a thermoplastic polymer resin such as nylon resin or polylactic acid (PLA).

Furthermore, the part incorporates at least one piezoelectric measurement device 4. In the present example, the part incorporates a single piezoelectric device.

In this example, the device 4 is made up of a single piezoelectric transducer 5 and two connection wires secured to said piezoelectric transducer 5. One is arranged over the transducer 5, and the other below it.

By way of example, the piezoelectric transducer 5 is a piezoelectric disk.

The disk is optionally made up of a piezoelectric ceramic such as Lead Zirconate Titanate (LZT or PZT) or a piezoelectric thermoplastic polymer such as polyvinylidene fluoride (PVDF), both of them being commonly commercially available.

Since the piezoelectric transducer 5 is thus disk-shaped, it presents two planar main faces.

Optionally, the piezoelectric transducer 5 presents a diameter lying in the range of 5 millimeters (mm) to 30 mm and preferably in the range 5 mm to 25 mm. By way of example, the diameter is 9 mm or 25 mm.

The piezoelectric transducer 5 presents small thickness. As a result, the piezoelectric transducer 5 is relatively non intrusive.

Preferably, the piezoelectric transducer 5 is as thin as possible.

By way of example, the piezoelectric transducer 5 has thickness lying in the range of 20 micrometers (μm) to 150 μm, and optionally thickness lying in the range 25 μm to 140 μm. For example a the piezoelectric transducer 5 has thickness of 80 μm or of 135 μm but this thickness could be thinner.

The piezoelectric transducer 5 is also arranged inside the part in such a manner that its two plane faces extend parallel to the two main faces 2 and 3 of the body 1 of the part.

The piezoelectric transducer 5 is optionally arranged at the center of the part, regardless of whether the “center” of the part is considered in depth, in width, or in length. For this purpose, a first cavity 15 is made in the body 1 of the part, with the piezoelectric transducer 5 being arranged in said cavity 15. The first cavity 15 is shaped to match the shape of the piezoelectric transducer 5. The first cavity 15 thus presents a planar cross-section that is substantially circular. Said planar cross-section presents a diameter slightly bigger than the one of the transducer 5 so that the latter can fit inside.

As mentioned above, the device 4 has a first connection wire 6 and a second connection wire 7. By way of example, the connection wires 6 and 7 are made of metal, e.g. of copper and for example of tinned copper.

Although the piezoelectric transducer 5 is incorporated entirely within the body 1 of the part, the connection wires 6 and 7 come out of the part so that the data measured by the piezoelectric transducer 5 can be transmitted to the outside. The data are for example stored (on a memory card, a computer connected to an acquisition chain . . . ) and/or are directly treated.

Preferably, a second cavity 16 is made in the body 1 of the part in order to receive the first connection wire 6 and a third cavity 17 is likewise made in the body 1 in order to receive the second connection wire 7. Optionally, the third cavity 17 and the second cavity 16 extend parallel to each other along a rectilinear direction X (in the present case being the longitudinal axis of the part). By way of example, said rectilinear direction X is parallel to the length of the part. Optionally, both cavities 16 and 17 open out into both of the lateral end faces of the part.

Optionally, the second cavity 16 and the third cavity 17 are not arranged one above the other. Preferably the cavities 16, 17 are arranged offset in relation to each other (according to a transverse direction Y that is orthogonal of direction X and that is not normal to planar cross-section of the first cavity 15).

Furthermore, the second cavity 16 is arranged below the first cavity 15 and the third cavity 17 is arranged above the first cavity 15. Furthermore, both cavities 16 and 17 also open out into the first cavity 15.

The second and third cavities 16 and 17 are preferably shaped to match the cylindrical shape of the connection wires 6 and 7, and thus present cross-sections that are circular with substantially the same diameter of the connection wires or are of a shape as close as possible to a circle with the same diameter of the connection wires. For example the second and third cavities 16 and 17 present cross-sections that are squared due to the additive method used to manufacture the part (as explained below). Cross-sectional dimensions of the second and third cavities 16 and 17 must be a little bit bigger than the diameter of the connection wires 6, 7, so that these latter can fit inside.

There follows a description of a method for manufacturing such a part in a first particular implementation of the invention.

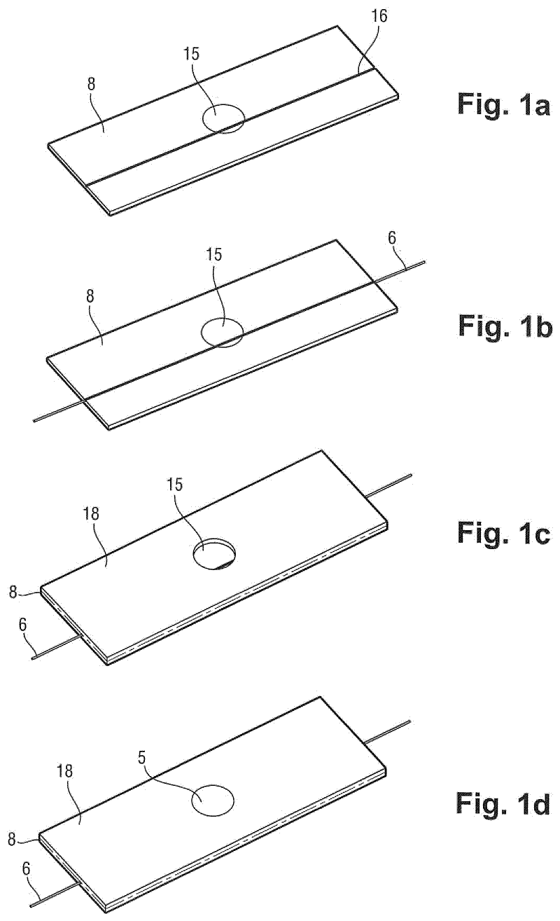

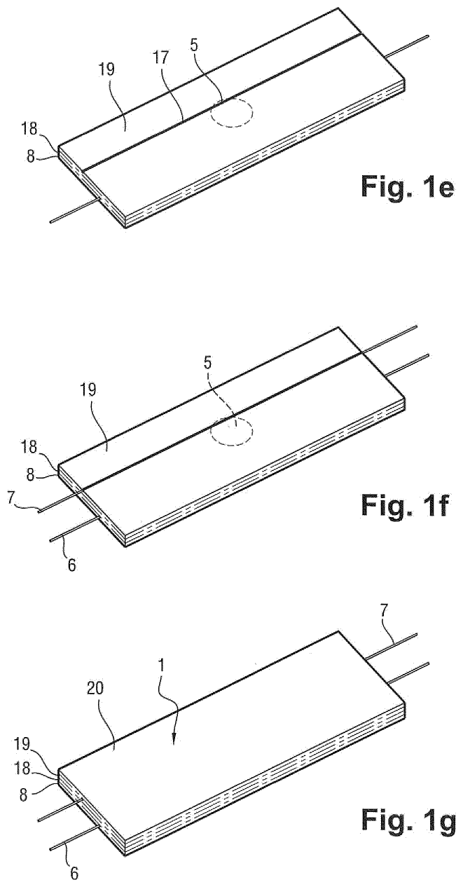

With reference to FIG. 1a, during a first step, a first portion 8 of the part is manufactured by an additive method. In this example, the first portion 8 incorporates the bottom and lateral walls of second cavity 16, and the bottom and very beginning of lateral wall of the first cavity 15. This first portion 8 is located at the bottom of the part and includes the bottom face 3 of said body 1.

The additive method is a method of three-dimensional (3D) printing. Optionally the additive method is a Fused Filament Fabrication (FFF).

At the end of the first step, the additive method is stopped. This stopping may be performed manually by an operator and/or automatically by a calculation member.

During the second step, and as shown in FIG. 1b, the first connection wire 6 is positioned into the second cavity 16 so that the first connection wire 6 projects from both longitudinal ends of the part 1. This step may be performed manually and/or automatically.

The first connection wire 6 is secured to the second cavity 16 and is not merely placed in said second cavity 16. For example, the first connection wire 6 is adhesively bonded in the second cavity 16 optionally using liquid glue.

This ensures that the first connection wire 6 does indeed remain in position in its second cavity 16.

Thereafter, with reference to FIG. 1c, in a third step, the additive method is launched again automatically and/or manually.

During this third step, the second cavity 16 is closed by the deposited material, except its area of interconnection with the first cavity 15 so that the portion of the first connection wire 6 located in this area can make direct electrical contact with the lower surface of the piezoelectric transducer 5 placed in the next step. The lateral wall of the first cavity 15 is finalized during this third step, in order to welcome the piezoelectric transducer 5 in the step to come.

At the end of the third step, the additive method is stopped automatically and/or manually.

Thus, during the third step, a second portion 18 of the part is created rightly above the first portion 8.

The additive method is the same as that used for all described steps.

In a fourth step and with reference to FIG. 1d, the piezoelectric transducer 5 is placed in the first cavity 15, thereby connecting electrically the piezoelectric transducer 5 to the first connection wire 6. This step may be performed manually and/or automatically.

Optionally, the piezoelectric transducer 5 is secured to the first cavity 15, and is not merely placed in said first cavity 15. For example, the piezoelectric transducer 5 may be adhesively bonded inside the first cavity 15; optionally using liquid glue.

This ensures that the piezoelectric transducer 5 does indeed remain in place in the first cavity 15.

Optionally, electrical contact between the piezoelectric transducer 5 and the first connection wire 6 is optimized at the beginning of this fourth step before the placement of the piezoelectric transducer 5. By way of example, some electrically conductive material is applied in a future contact area between the piezoelectric transducer 5 and the first connection wire 6, such as a metallic material, e.g. a material based on silver. In the present example, the material is a silver varnish. For example, at least one drop of such a material is applied in the future contact area between the piezoelectric transducer 5 and the first connection wire 6. In the present example, a drop of silver varnish is applied on top of first connection wire 6 portion which is in the first cavity 15 area.

Then, when the piezoelectric transducer 5 is arranged inside the first cavity 15, it covers the portion of the first connection wire 6 which is covered by the silver varnish, ensuring an optimized electrical contact at the interface between the first connection wire 6 and the piezoelectric transducer 5.

In a fifth step, and with reference to FIG. 1e, the additive method is launched again (manually and/or automatically) so that the first cavity 15 with the piezoelectric transducer 5 inside is progressively closed by material deposition and the third cavity 17 is begun to be built. More precisely, in this step, the lateral walls of third cavity 17 are built and the first cavity is not completely closed. The portion of the first cavity 15 not being closed corresponds in fact to the intersection of the third cavity 17 with the first cavity 15, so that, in the next step, the second connection wire 7 can be placed inside the third cavity 17 to contact the upper surface of the piezoelectric transducer 5 on that intersection.

Thus, during the fifth step, a third portion 19 of the part is created rightly above the second portion 18.

At the end of the fifth step, the additive method is stopped manually and/or automatically.

The additive method is the same as that used for all described steps.

In a sixth step, and with reference to FIG. 1f, the second connection wire 7 is then positioned into the third, cavity 17 in such a manner that the second connection wire 7 projects from both laterals ends of the part 1 in parallel with the first connection wire 6 and contacts the upper surface of the piezoelectric transducer 5.

This step may be performed manually and/or automatically.

Optionally, electrical contact between the piezoelectric transducer 5 and the second connection wire 7 is optimized. By way of example, some electrically conductive material is applied in an area of contact between the piezoelectric transducer 5 and the second connection wire 7, such as a metallic material, e.g. a material based on silver. In the present example, the material is a silver varnish. For example, the material is applied once the second connection wire 7 in place in the third cavity 17.

By way of example, at least one drop of such a material is applied in an area of contact between the piezoelectric transducer 5 and the second connection wire 7. In the present example, a drop of silver varnish is applied on top of second connection wire 7 portion which is contacting the piezoelectric transducer 5 in the first cavity 15. This will enhance electrical contact between the second connection wire 7 and the piezoelectric transducer 5. Optionally, the second connection wire 7 is secured to the third cavity 17 and is not merely Placed in said second cavity 17. For example, a layer of adhesive, such as liquid glue, is applied in the third cavity 17 before placing the second connection wire 7 inside.

In a seventh step, and as can be seen in FIG. 1g, the additive method is launched again (manually and/or automatically) and stopped (manually and/or automatically) when the manufacturing of the part is achieved.

The additive method is the same as that used for the first step.

Thus, during the seventh step, a fourth portion 20 of the part is created rightly above the third portion 19. This fourth portion is located at the top of the part and includes its top face 2.

By using the additive method, the two connection wires 6 and 7 are thus embedded inside the body 1 of the part, as is the piezoelectric transducer 5.

A part 1 is thus created having a piezoelectric measurement device 4 integrated therein by means of a method that is simple and fast.

It should be reminded that the employed three-dimensional printing method (FFF) is performed using a machine, like a 3D printer, having at least one injection nozzle that deposits the material(s) on a reception plate, with the successive layers of the deposited material(s) progressively forming the final part.

The movements of the injection nozzle(s) follow instructions contained in a file that is the combination of a Computer Assisted Design (CAD) file containing the 3D STL geometry of the part to build (including the three cavities 15, 16 and 17) along with the corresponding manufacturing instructions to be performed by the 3D printer. This file is executed by a program stored in a calculation member (a processor, a calculator . . . . ) connected to the 3D printer and/or included in the 3D printer.

This file is configured to take into account the three cavities 15, 16, and 17 so that the cavities are formed the way they were designed in the CAD file, jointly with the operation of forming the body 1 of the part. The cavities 15, 16, and 17 are thus created automatically when the part is built. The additional elements (connection wires and transducer) are successfully embedded inside the part thanks to the corresponding stops of the program. Preferably, these stops are automatic and so are being programmed inside the file read by the 3D printer. Therefore the manufacturing of the 3 cavities 15, 16 and 17 does not require any additional action such as drilling for example.

Advantageously, the presence of the cavities 15, 16, and 17 enables the piezoelectric transducer 5 and its connection wires 6 and 7 to be very well integrated into the part 1, which minimizes their intrusiveness.

Preferably, the cavities 15, 16, and 17 are defined in such a manner to present dimensions that are as close as possible to the dimensions of the element that each of them is to receive, so as to avoid empty spaces/interfaces in the part as much as possible during all manufacturing steps.

Naturally, the above-described method can be implemented to manufacture other types of parts with different simple or complex geometries.

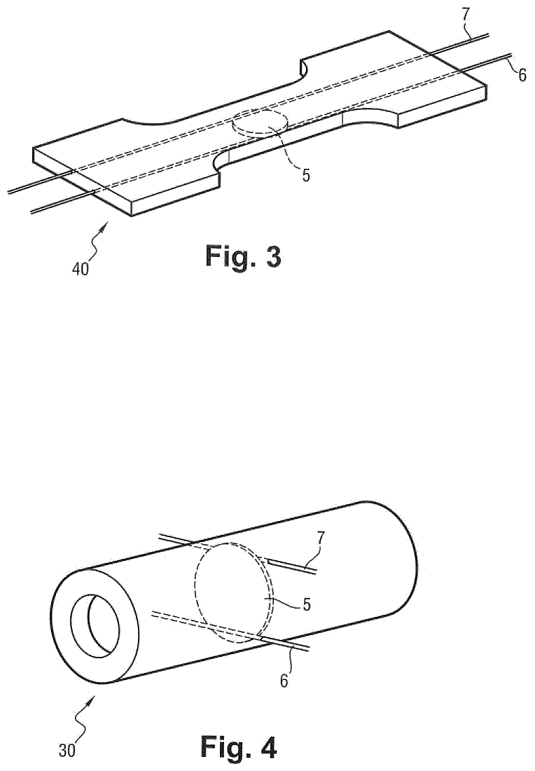

FIG. 3 thus shows a part shaped as a testpiece 40, which has been manufactured using the same previously described method, and has the shape of a dumbbell sample for mechanical tests. Testpiece 40 may be used for example in tensile and/or compression tests.

FIG. 4 shows another part that can be manufactured using such a method. This part is a musical percussion tool 30, such as a drumstick.

The part has a cylindrical shape.

Optionally, the piezoelectric transducer 5 is embedded so that its main faces extend parallel to the two plane faces of the body of the part, which thus includes the three previously described cavities 15, 16 and 17 receiving the corresponding piezoelectric transducer 5 and its connection wires 6 and 7.

Each of the connection wires 6 and 7 may extend independently of the other connection wire so they project themselves radially from both sides of the body of the part, or at least one of the connection wires 6, 7 may extend in a way so as project radially form only one side of the body of the part.

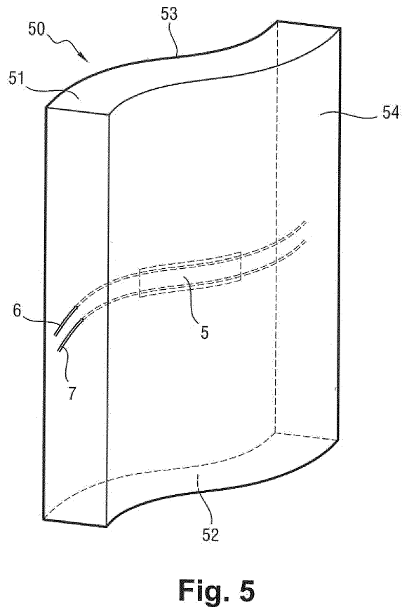

FIG. 5 shows another part 50 that can be manufactured using such a method.

The part 50 is curved.

In this case the transducer 5 could be arranged so that its main faces extend parallel to plane upper and lower faces 51, 52 of the body of the part 50 or could be arranged so that its main faces follow the curvature of the part 50. As illustrated, the main faces of the transducer 5 extend to remain parallel to the main curved faces 53, 54 of the part, making the transducer 5 follow the curvature of the part 50. The body of the part thus includes the three previously described cavities receiving the corresponding piezoelectric transducer 5 and its connection wires 6 and 7.

The transducer 5 is for example made up of PVDF, as it has to be flexible to follow the curvature of its host Part.

The invention thus makes it possible to manufacture numerous parts regardless of whether they are simple or complex it shape: rectilinear, curvilinear, axisymmetric, of small thickness . . .

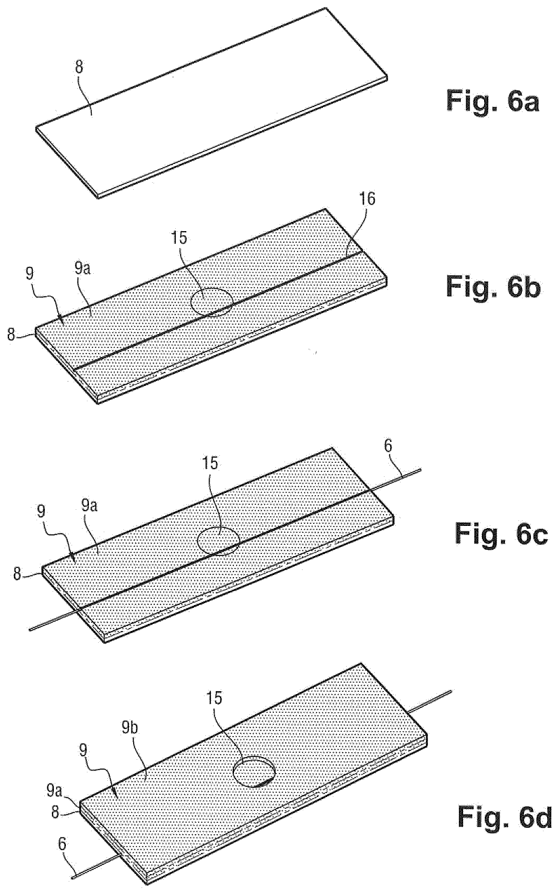

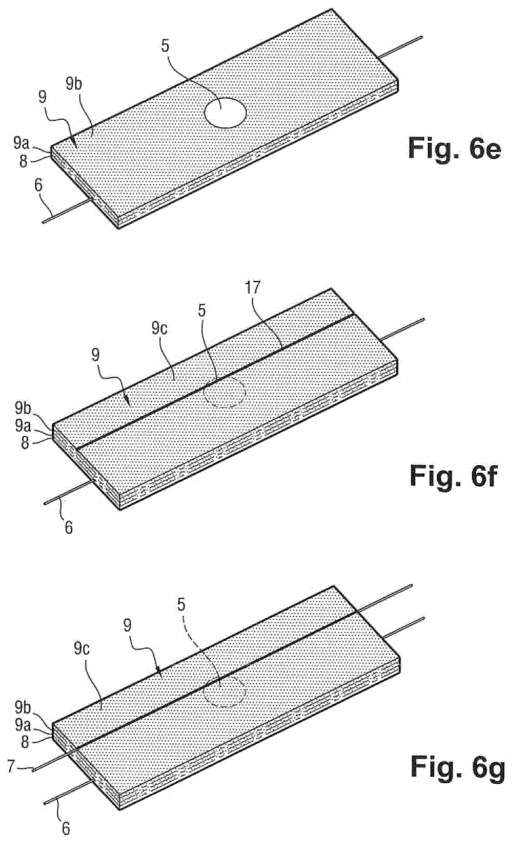

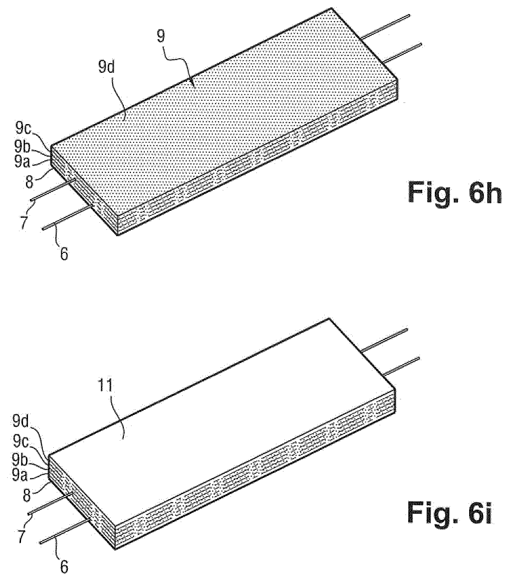

With reference to FIG. 6a to FIG. 6i, such parts may also be manufactured using a second particular implementation of the invention-.

In fact whereas the part of the first particular implementation of the invention, was made in a non electrically conductive material, in the second Particular implementation of the invention, the part is mainly made in an electrically conductive material. For example the used material is a nylon/carbon fiber composite.

However the part is also configured so that at least one of the cavities, preferably at least the cavities that are to receive the connection wires, and more preferably all of the cavities are electrically insulated.

By way of example, and still using an additive method, an intermediate portion 9 of electrically insulating material composes the part at the level of the different cavities. In fact this intermediate portion 9 is composed of four sub-portions 9a, 9b, 9c, 9d: the first sub-portion 9a comprising at least the bottom and main part of lateral walls of the second cavity 16, the second sub-portion 9b comprising the main part of the lateral walls of the first cavity 15 (second sub-portion 9b corresponds in fact to the second portion 18 of the first embodiment), the third sub-portion 9c comprising at least the main part of the lateral walls of the third cavity 17 (third sub-portion 9c corresponds in fact to the third portion 19 of the first embodiment) and the fourth sub-portion 9d comprising at least the top of the third cavity 17.

By way of example, the intermediate portion 9 is a resin such as a nylon resin.

For example injection nozzles work alternately layer by layer, the first one for the carbon fiber and the second one for the nylon resin so as to create a first portion 8 in a nylon/carbon fiber composite.

Before the beginning of creation of the second cavity 16 (between steps 6a and 6b), the injection nozzle depositing the carbon fiber is stopped (automatically and/or manually) letting only the nozzle depositing the nylon resin work so as to create successively sub-portions 9a, 9b, 9c and 9d (as showing steps 6b to 6h). The carbon fiber nozzle will stay inactive until the closing of the third cavity 17 by the nylon resin and the end of manufacturing of sub-portion 9d and so of intermediate portion 9 (see step 6h).

Then, both nozzles will be allowed to work together again, finishing the part using the initially used nylon/carbon fiber composite material (as illustrated in FIG. 6i).

In fact the steps of the first particular implementation of the invention remain unchanged, with the same stops happening at the same times, and the same bonding and electrical optimization actions to embed the piezoelectric measurement device. However in the second Particular implementation of the invention we add additional intermediate steps (stopping the conductive fiber nozzle and launching again the conductive fiber nozzle) in order to have an intermediate portion 9 that is an electrically insulated portion.

This step of temporarily stopping the conductive fiber nozzle ensures the piezoelectric measurement device 4 composed of the piezoelectric transducer 5 with its two connection wires 6 and 7 to be electrically insulated inside its host conductive composite part, as the three cavities 15, 16 and 17 will be composed of insulating resin. This will avoid short-circuiting the piezoelectric measurement device 4, this one being embedded inside an electrically insulating resin portion 9 located inside the global part.

This step of temporarily stopping the conductive fiber nozzle is performed manually and/or automatically.

This intermediate portion 9 containing the three associated cavities 15, 16 and 17 is here a nylon resin but could be any electrically insulating resin such as any kind of polymer resin usable in the additive method employed. In fact the intermediate portion 9 is obviously composed of several deposited layers.

Preferably, this intermediate portion 9 has a small thickness. This intermediate portion has for example a thickness substantially equal to the combined thicknesses of the transducer 5 and its two connection wires 6 and 7.

Whatever the embodiment described, the implementation described, or the variant described, the invention makes it possible to create a part having at least one embedded piezoelectric measurement device, in a simple and fast way.

There are multiple applications for such parts created by the invention.

In a first possibility, since the transducer is embedded from the manufacturing stage, it is possible to monitor the manufacturing process of the part from the moment the transducer is embedded. The transducer can then provide information in real-time about the progress of the later stages of fabricating the part, meaning the deposition of the remaining material layers needed to finish the part. This application is named Process Monitoring (PM). The transducer thus has the potential to provide data about cooling rates of the deposited material, the development of residual stresses into the part during its manufacturing, the presence of porosities in the part (generally due to moisture in the used reels of raw materials), any phase change of the deposited material, etc.

The transducer can thus make it possible to evaluate the quality of the finished part and it can, also facilitate performing the method (e.g. by detecting when the part has finished its cooling phase, in order to be able to extract the part from the additive manufacturing machine without damaging the part).

In a second possibility, the transducer also makes it possible to monitor the health state of the part throughout its lifetime (in service) and not only when it is being created. This monitoring can be performed in real-time, without any need to stop the working structure in which the part is used. This application is called Structural Health Monitoring (SHM). In this configuration, the piezoelectric transducer is protected from its external environment, and is more sensitive to the damage of the part because it detects information specific to the material without any alterations or mode changes.

For example, the transducer makes it possible to evaluate the stresses and/or strains to which the part is subjected in real-time during its service life when no structural anomaly is identified; or to detect in real-time the initiation of damage into the part and track the propagation of such damage until the final failure of the part.

Thus, depending on pre-defined damage thresholds determined thanks to the data provided by the embedded transducer, it is possible to decide when the part in question needs to be repaired or replaced in case of too severe damage.

In a third possibility, the transducer may be used to obtain a better understanding of the challenges and difficulties coming with the use of an additive manufacturing method, e.g. such as those associated with three-dimensional printing.

Specifically, such a method still presents difficulties which are not entirely solved, such as the roughness of the resulting part, a gradient of mechanical properties within the part resulting from the presence of a thermal gradient associated to the cooling of the successive deposited layers, phase transitions occurring inside the material used while the part is cooling, cooling rates . . .

Thus, a transducer that is directly embedded inside a part while it is being fabricated makes it possible to monitor and quantify those various parameters. In the short term, it is possible to estimate the quality of the part at the end of its manufacturing and to monitor its health in real-time when this one works in service. In the long term, however, it is possible to achieve a better understanding of the various thermal, chemical, mechanical . . . phenomena that are associated with the employed additive manufacturing method.

In a fourth possibility, the transducer may be used as a sensor but also as an actuator. Specifically, it is possible to inject an electric current deliberately into the transducer, thereby causing the transducer to strain as a result of its piezoelectric properties, allowing it to vibrate and propagate Ultrasonic (US) waves through the part, which is another way to perform SHM. Thus, it is possible to evaluate the integrity of the part directly from the inside. As an example, it is possible for the transducer to propagate different kind of waves into the part, such as plate (Lamb) waves or classical ultrasonic waves.

The transducer can thus deal with both passive information (when it has not been activated as an actuator) and also active information (when it has been activated as an actuator and thereafter when it has subsequently sensed the effects of such actuation).

In a fifth possibility, a small number of identical parts are manufactured and tested in order to define the mechanical limits of such parts, e.g. in order to define damage thresholds thanks to the informations provided by the embedded transducer. Subsequently, use is made of such thresholds definitions while monitoring other parts in the same series, e.g. in order to decide whether a part needs to be repaired or replaced.

In a more general way, the invention makes it possible to create parts suitable for use in numerous and varied fields such as for example offshore (optionally to monitor remotely the health of platforms), aeronautics/aerospace (optionally to monitor the health of a wing in real-time and/or for Process Monitoring (PM) or Structural Health Monitoring (SHM) of composite parts implemented into an airplane), pipelines (optionally to monitor pipelines in real-time in order to avoid conventional and onerous ultrasound inspections), pressurized tanks (optionally for PM and/or SHM of the tanks).

The invention is particularly advantageous for manufacturing critical additively manufactured parts such as parts that are subjected to high mechanical stresses and/or parts that tend to wear rapidly and/or parts that are subjected to high levels of environmental stress (humidity, temperature, wind, etc.) and/or parts employed in fields where it is difficult to isolate them in order to control their structural integrity as a result of the difficulty of access. It is also advantageous in case of impossibility to stop the structure embedding the part to be monitored, as it will provide a continuous SHM information flow without any need to take the corresponding part out of service.

It should be understood that although the invention makes it easier for a part to be mass-produced, the invention can naturally be used for manufacturing a single part or a very short run of parts.

Naturally, the invention is not limited to the previously described implementations, and variants may be applied without going beyond the ambit of the invention.

In particular, although the described measurement device comprises a transducer with two connection wires, the device could be different, and for example, it could be constituted by a transducer only (without any connection wires). The embedded transducer could then communicate information to its external environment via for example a wireless link. For example, the transducer may be a piezoelectric Surface Acoustic Wave (SAW) transducer.

Consequently, the part could include a different number of cavities from the one previously described in the invention (independently of the number of transducers and associated connection wires), since one or more elements (transducer and/or connection wire) could be housed in the same cavity. For example, the part could include only one cavity. Optionally, each element of the piezoelectric measurement device is arranged in its own cavity so that the part comprises as many cavities as the number of elements of the piezoelectric measurement device.

Furthermore, the manufactured part(s) could present shapes different from those described. Regardless of the shape of the body of the part, the transducer and/or its associated connection wires may be arranged differently from the arrangement described. The transducer does not need to be embedded in the mass center of the body of the part and/or does not need to be parallel to at least one of the faces of the body of the part. Everything depends on the application, intended for the part and/or on the region of the part that is wanted to be studied and/or monitored. For example, the transducer could be placed in a strategic region of the part, such as a region of the part that is the most subjected to mechanical strain, to thermal stresses, etc. . . . Or the transducer could be arranged in the immediate proximity of such a region, but not in the region itself, in order to avoid over-stressing of the transducer which could lead to its malfunctioning/failure.

The part could include a higher number of piezoelectric measurement devices than stated above.

The part could thus incorporate at least two piezoelectric measurement devices embedded in a common plane of the part, i.e. inserted in the same material layer deposited while fabricating the part.

Alternatively, or also, the part could host at least two piezoelectric measurement devices embedded in two different planes of the part, i.e. inserted in different material layers deposited while fabricating the part. Under such circumstances, once the first piezoelectric device has been embedded in a first portion of the part as previously described, the method would be repeated so that another portion of the part, containing another Piezoelectric measurement device, would be fabricated over the first portion. This would be repeated until the wanted number of piezoelectric devices are implemented within the thickness of the final part.

If the part has at least two piezoelectric measurement devices, they may operate in an independent manner and/or they may operate as a network, with the data coming from the various transducers being gathered in order to be processed together. Operating the embedded transducers as a network makes it possible to improve the quality of the information (in terms of accuracy, redundancy, richness of information or crosschecking . . . ). It can then also be more comfortable to estimate the residual stresses in the part which are associated with manufacturing, or to map more easily/accurately the position of a defect in three dimensions, an incipient damage or its progress through the monitored part.

Also, if at least two transducers are arranged in the part, it is possible to use one of the transducers as an actuator and the other passively as a sensor (forming for example an acoustic US device) to monitor the corresponding area of the part being between the two working transducers.

The transducer do not need to be in the shape of a disk, for example, it could be a ring, a plate, one or several fibers . . .

The transducer could also present other dimensions than those previously stated. As an example, the transducer could be of smaller thickness than previously described.

The piezoelectric material composing the transducer could be different from Lead Zirconate-Titanate (LZT/PZT) ceramic, for example, it could be a polymer such as a thermoplastic polymer like for example PolyVinylidene Fluoride (PVDF).

This piezoelectric material may be used as such, or in a composition including some of the above-mentioned compounds. As an example, the composition could comprise a resin and/or a powder incorporating any of the above-mentioned compounds, such as polymer resin mixed with a piezoelectric ceramic powder. This piezoelectric material may be used as such, or may be surrounded by conductive armatures in order to improve its electrical connection and/or to be used as a capacitor.

Instead of using a previously-manufactured transducer (i.e. a transducer that has been purchased commercially and that is used as such), the transducer could be extracted (for example by cutting), e.g. from a piezoelectric material sheet. This makes it possible to define the shape of the transducer as desired.

Thus, the transducer could be cut out in the desired shape from a PVDF sheet commercially purchased, or manually obtained using a manufacturing technique such as electrospinning. The transducer would then be flexible and highly stretchable, whereas a ceramic transducer will be rigid. Furthermore, the embedded transducer could be made of a material different from those previously described. For example, it could be made of a composite material such as an Active Fiber Composite (AFC) or a Macro Fiber Composite (MFC).

The invention could also be applied to another composite material. For example, one possible composite material is a material having its fibers constituted by glass fibers and/or carbon fibers and/or any other kind of fibers (like the ones commercialized under the trademark Kevlar, or bio-based fibers, etc.). The associated matrix could be a thermoplastic resin such as a resin based on nylon. In a general manner, it is possible to use any type of fiber and/or any type of resin as long as the fiber and the resin can be used in additive methods.

Generally, the base material of the part (whether or not it incorporates fibers) could be different from the above-mentioned resin. For example, it is possible to use a material based on a thermoplastic polymer, a concrete (optionally reinforced depending on whether or not the material of the body is itself composite) as long as the base material can be used in additive methods. For example the base material could be a PA, PE, PPSU, etc. Any type of piezoelectric material (PZT, PVDF . . . ) for the associated measurement device may be associated with any base material (suitable for additive methods) to manufacture the part.

Furthermore, instead of the three-dimensional printing method used and described previously, which was Fused Filament Fabrication (FFF), it is possible to use other three-dimensional printing methods like Fused Deposition Modeling (FDM), or powder technology (Selective Laser Sintering (SLS), Selective Laser Melting (SLM)) . . . This might possibly determine the nature of the part (composite or not composite). Optionally, the additive method can be switched from one of another when manufacturing a same type of part. Nevertheless, it is always possible to associate any piezoelectric material (PZT, PVDF . . . ) with any of these methods. Nevertheless, care should be taken to avoid using an additive method in which the temperature rises to levels that are higher than those that can be withstood by the measurement device in question, in order to avoid damaging it. Likewise, care should be taken to have a part of sufficient thickness to cover both faces of the transducer. Depending on the material of the body of the part and/or of the measurement device, it may be necessary to insulate the measurement device, at least partially, as described above.

The measurement device could be insulated electrically in another manner from the one previously described, for example, the connection wires could be sheathed using a sheath of electrically insulating material, and/or the connection wires and/or the transducer could be coated using an electrically insulating paint. Other material than silver varnish could be used to assure electrical contact inside the measurement device like another material based on conductive particles as for example a conductive particles-filled adhesive.

Even if the connection wires extend in parallel in the part, the connection wires could be arranged in a different manner for example orthogonal to each other or transversally to each other.

Even if in the present case, the connection wires open out into both of the lateral end faces of the part, each connection wire could open out only into one of the two lateral end faces of the part.

The step of securing the transducer and/or the connection wires to at least one of the cavity is optional.

The step of optimizing the electrical contact between the transducer and at least one of the connection wires is optional.

1. A method of manufacturing a part having at least one piezoelectric measurement device integrated inside, the method comprising the following successive steps:
Using an additive method to obtain at least a first portion of the part, with at least one cavity being at least partly formed in said portion;
Stopping the additive method;
Placing at least one piezoelectric transducer of the piezoelectric measurement device in said cavity; and
Using an additive method to create at least a second portion of the part so that the at least one transducer is held captive between at least the first and second portions.

2. A method according to claim 1, wherein the measurement device includes, in addition to the piezoelectric transducer, two connection wires that are connected to said transducer.

3. A method according to claim 2, wherein at least one of the first portion and the second portion includes a second cavity, being at least partly formed in one of said portions, said second cavity being defined during additive method of the portion in question, at least one of the connection wires being arranged in said second cavity.

4. A method according to claim 2, including the step of securing at least one of the connection wires to its cavity inside the part.

5. A method according to claim 2, including the step of applying electrically conductive material in at least one area of contact between the transducer and and at least one of the connection wires.

6. A method according to claim 1, wherein the piezoelectric transducer is based on PZT material.

7. A method according to claim 1, wherein the piezoelectric transducer is based on PVDF material.

8. A method according to claim 1, wherein at least one of the two portions is made of polymer material or composite material.

9. A method according to claim 1, wherein at least one of the two portions is based on thermoplastic polymer material.

10. A method according to claim 1, including the step of electrically insulating the at least one cavity.

11. A method according to claim 1, including the step of securing at least the transducer to its cavity.

12. A method according to claim 11, wherein the transducer is adhesively bonded to its cavity in order to secure it to its cavity.

13. A method according to claim 1, including the step of embedding at least two piezoelectric measurement devices in the part.

14. A method according to claim 13, including the step of inserting two piezoelectric devices in the same or in different layers of the part.

15. A computer program comprising instructions enabling a calculation member to perform the method according to claim 1.

16. Storage means for storing a computer program comprising instructions enabling a calculation member to perform the method according to claim 1.
